(19) United States
(12) Patent Application Publication
(10) Pub. No.: US 2008/0104710 A1
(43) Pub. Date: May 1, 2008

(54) Software utilization grace period

(75) Inventors: Michael Jorden, Redmond, WA (US); Aidan Hughes, Bellevue, WA (US); John Jennings, Everett, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/540,861

(22) Filed: Sep. 29, 2006

(51) Int. Cl. H04L 9/32; H04N 7/16; G06F 17/30; G06F 7/04; G06K 9/00; H04L 9/00; H03M 1/68; H04K 1/00

(52) U.S. Cl. 726/27; 726/28; 726/29; 726/30; 705/54

(57) ABSTRACT

A grace period is provided during which the features of a software application may be fully utilized and appreciated without requiring entry of a product identification key code or other authorization code. After loading a software application onto a user's computer, a grace period is provided during which the software application may be booted and used with all its associated features and functionalities before requiring entry of a product identification key code or other authorization code. At the end of the grace period, entry of the appropriate product identification key code or other authorization code is required, followed by activation of the software application.

### BACKGROUND

Computer software applications are typically loaded onto a computer from a memory medium such as a compact disc or from an Internet download or from other mediums on which software applications may be stored. In order to utilize a software application on a user's computer, an activation procedure often must be accomplished for a loaded application to enable full operation of the application and to notify an activation authority, such as the application manufacturer, that the appropriately obtained application is now in use on the user's computer. Such activation procedures allow manufacturers/marketers of software applications to eliminate or reduce unauthorized use of software applications (also known as, software piracy).

In many cases, a product identification key code or other authorization code accompanies an acquired software application and must be entered during a software setup process to enable full use of the features of the software application. In some cases, a software application may be loaded and launched without entry of an appropriate product identification key code or other authorization code, but the application will run with a greatly reduced feature set until the product identification key code or other authorization code is entered. In other cases, after entry of a product identification key code in a software setup process, a grace period is provided in which a full set of software application features may be utilized before software activation must be performed. During the software activation, product information contained in the software application may be associated with the computer onto which the software application is loaded, or product information may be passed to the software application manufacturer via mail or via a distributed computing network such as the Internet. Unfortunately, entry of the product identification key code prior to initial use of the software application is seen by some software users as a barrier to initial enjoyment of the software application that often taints the first impressions of the software user regarding the features of the software application.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing a grace period during which the features of a software application may be fully utilized and appreciated without requiring entry of a product identification key code or other authorization code. After loading a software application onto a user's computer, a grace period is provided during which the software application may be booted and used with all its associated features and functionalities before requiring entry of a product identification key code or other authorization code. Thus, an initial use of the software application is provided without requiring entry of a product identification key code so that the user may fully experience the features of the software application without delay. At the end of the grace period, entry of the appropriate product identification key code or other authorization code is required, followed by activation of the software application. If a user enters the appropriate product identification key code or other required authorization code during the grace period, the user then may utilize features and/or functionalities of the associated software application prescribed by the product identification key code or other required authorization code.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1A illustrates an exemplary computing operating environment.

FIG. 1B illustrates a computer-generated dialog box for receiving entry of application activation information and for providing un-activated use of a software application.

FIG. 2 is a logical flow diagram illustrating a method for software application setup.

FIG. 3 is a logical flow diagram illustrating a method for software application startup.

### DETAILED DESCRIPTION

As briefly described above, embodiments of the present invention are directed to providing a grace period during which the features and functionalities of a given software application may be utilized and appreciated without requiring entry of a product identification key code or other authorization code. After use of the software application for a prescribed number of software application “boots” during which the software application is started up or after use of the application for a prescribed duration, a product identification key code or other authorization code provided by the software application manufacturer must be entered, and the software application must be activated. If a product identification key code or other required authorization code is entered during the grace period before the grace period has expired, the software application may be utilized, according to the entered product identification key code, for the remaining portion of the grace period before software activation is required. According to another embodiment, once the product identification key code or other required authorization code is entered, application activation must be immediately performed.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

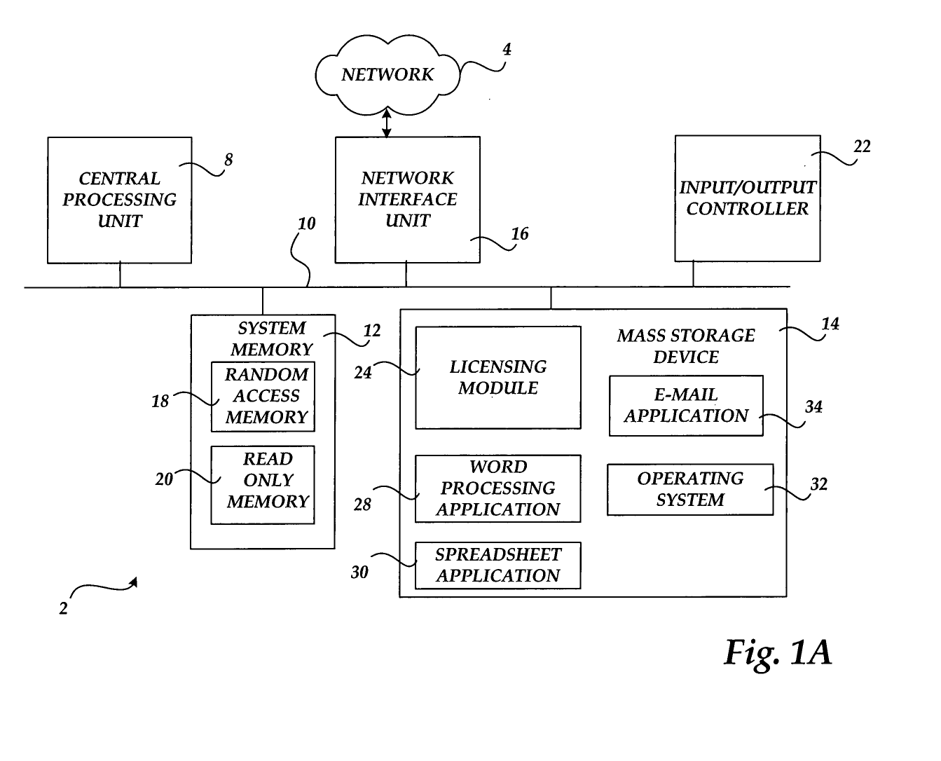

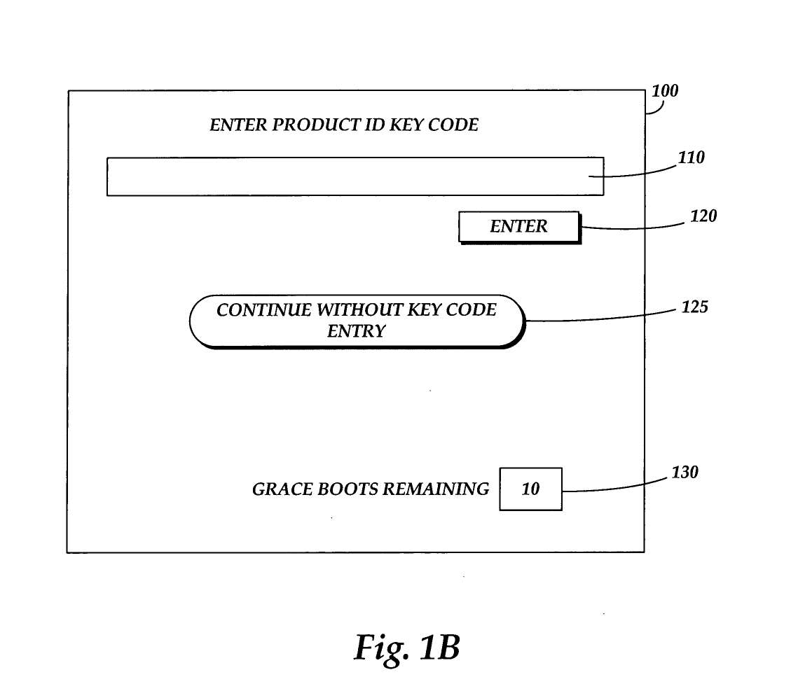

Referring now to the drawings, in which like numerals refer to like elements through the several figures, aspects of the present invention and an exemplary computing operating environment will be described. Referring now to FIG. 1A, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 1A, an illustrative operating environment for embodiments of the invention will be described. As shown in FIG. 1A, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 32 suitable for controlling the operation of a networked personal computer, such as the WINDOWS® operating systems from MICROSOFT CORPORATION of Redmond, Wash. The mass storage device 14 and RAM 18 may also store one or more program modules. In particular, the mass storage device 14 and the RAM 18 may store application programs, such as a word processing application 28, a spreadsheet application 30, e-mail application 34, drawing applications, etc. According to an embodiment, a licensing module 24 is included for managing application activation process as described below.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Referring still to FIG. 1A, according to embodiments of the present invention, the licensing module 24 is provided in association with a given software application, for example, the word processing application 28, the spreadsheet application 30, the electronic mail application 34, or any other software application for which product activation is required. As briefly described above, in order to utilize a software application on a user's computer, an activation procedure typically must be accomplished for a loaded application to enable full operation of the application and to notify an activation authority, such as the application manufacturer, that the appropriately obtained application is now in use on the user's computer. According to an embodiment, activation includes entry of a product identification key code or other authorization code, followed by product activation. As should be appreciated by those skilled in the art, product activation may include implementation of a mathematical algorithm that ties features of the software application to components of the computer 2 so that the software application may only be used with the computer 2 on which it is initially loaded. Alternatively, product activation may include the process of contacting the manufacturer via telephone or via a distributed computing environment, such as the Internet, to notify the manufacturer that the authorized software application is being utilized on the associated computer 2 in association with entry of the product identification key code or other manufacturer's authorization code.

A product identification key code or other authorization code is typically provided by a manufacturer or distributor of a given software application to an authorized user of the software application. The product identification key code or other authorization code may be in the form of an alpha-numeric string. Such codes are also sometimes referred to by software manufacturers or distributors as passwords. For example, a product identification key code may be provided on the labeling or packaging of a compact disc purchased by a user and containing a desired software application. Alternatively, if a software application is pre-loaded on a computer 2 purchased by the user, the product identification key code or other activation code may be provided with licensing materials accompanying the purchased computer. According to other alternatives, a software application may be purchased via a distributed computing environment, such as the Internet, and a manufacturer's product identification key code or other authorization code may be transmitted to the user electronically. According to yet other alternatives, a product identification key code or other authorization code may be embedded directly within a storage medium, for example, CD-ROM or DVD, or the code may be preloaded on a purchased computer.

According to an embodiment, the licensing module 24 associated with the software application purchased, rented or otherwise acquired by the user allows the software application to be loaded onto the computer 2 and allows the software application to be fully utilized during a grace period before required entry of a product identification key code or other authorization code. During the grace period, a prescribed number of application “boots” is provided. For example, a given software application may have an associated grace period of 25 boots which means that the application may be loaded onto the computer 2 and may be subsequently booted for use on the computer 25 times before required entry of the product identification key code or other authorization code. During the grace period, the licensing module 24 maintains a count of application boots or startups to ensure that the application may not be utilized beyond the grace period. Alternatively, the grace period may include a time period during which the full functionality of the software application may be utilized. In this case, the licensing module 24 maintains a time clock after initial startup and measures the total amount of elapsed usage time.

According to embodiments, during the grace period, an enhanced set of application features may be provided to the user that will be unavailable after entry of the product identification key code and after performance of the required software product activation. For example, if a user purchases a home version of a popular software application that contains fewer features than a business version of the same software application; all features available under the business version of the software application may be provided to the user during the grace period. At the end of the grace period and after product identification key code entry and subsequent activation, only those features associated with the purchased version of the software application, for example, the home version will be allowed by the licensing module 24. Such utilization of a fuller set of software features is advantageous because the user is provided a “preview” of the more advanced features that may be available to the user if the user decides to subsequently purchase the version of the software application containing the larger set of features. Alternatively, during the grace period, a reduced functionality feature set may be provided for the software application, and a warning or other notification may be provided to the user that a more advanced feature set will be provided upon entry of the required product identification key code or other required authorization code along with the required application activation.

After all grace boots have been utilized during the grace period, or after the prescribed grace time duration has elapsed, the licensing module 24 may cause the associated application to enter a reduced functionality mode in which only a small set of the features of the application may be utilized until the product identification key code and accompanying activation are entered and performed. As should be appreciated, the reduced functionality mode may include a complete shutdown of the associated application. As briefly described above, if a user enters a required product identification key code or other authorization code during the grace period, according to one embodiment, the licensing module 24 will allow the user to continue using the software application for the remaining term of the grace period before software activation is required. For example, if the user enters the product identification key code after five boots of a 25 boot grace period, the user may use the software application for the remaining 20 boots before software activation is required. Alternatively, after product identification key code or other authorization code is entered by the user, software activation must be immediately performed.

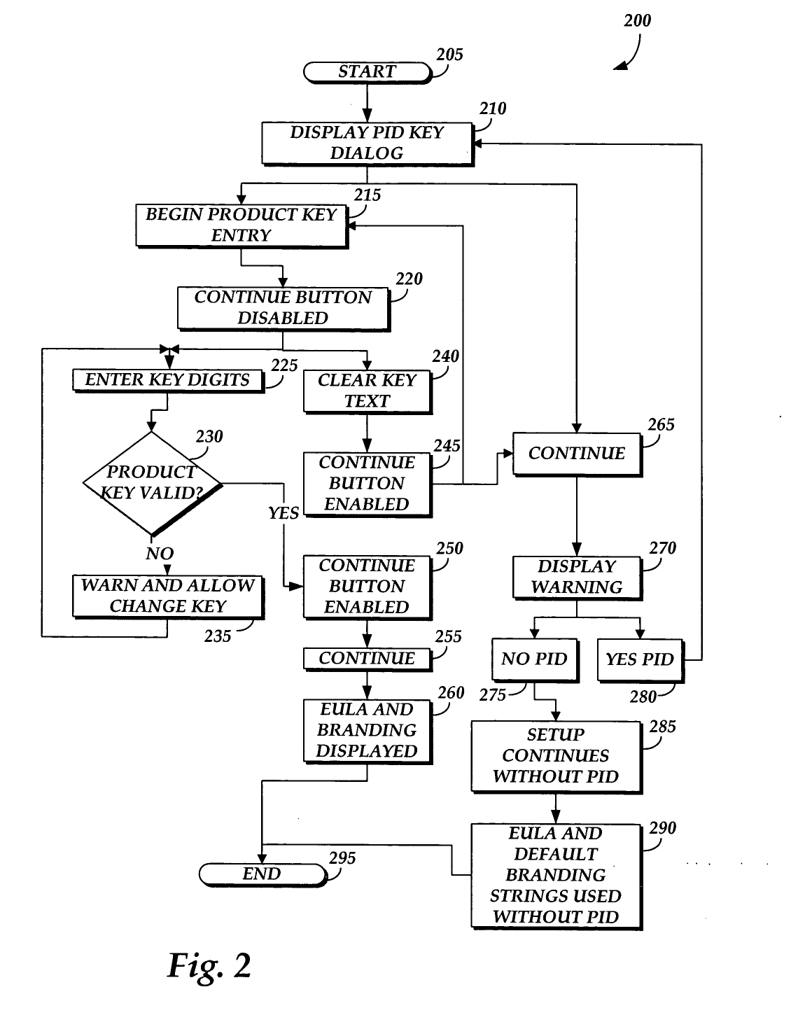

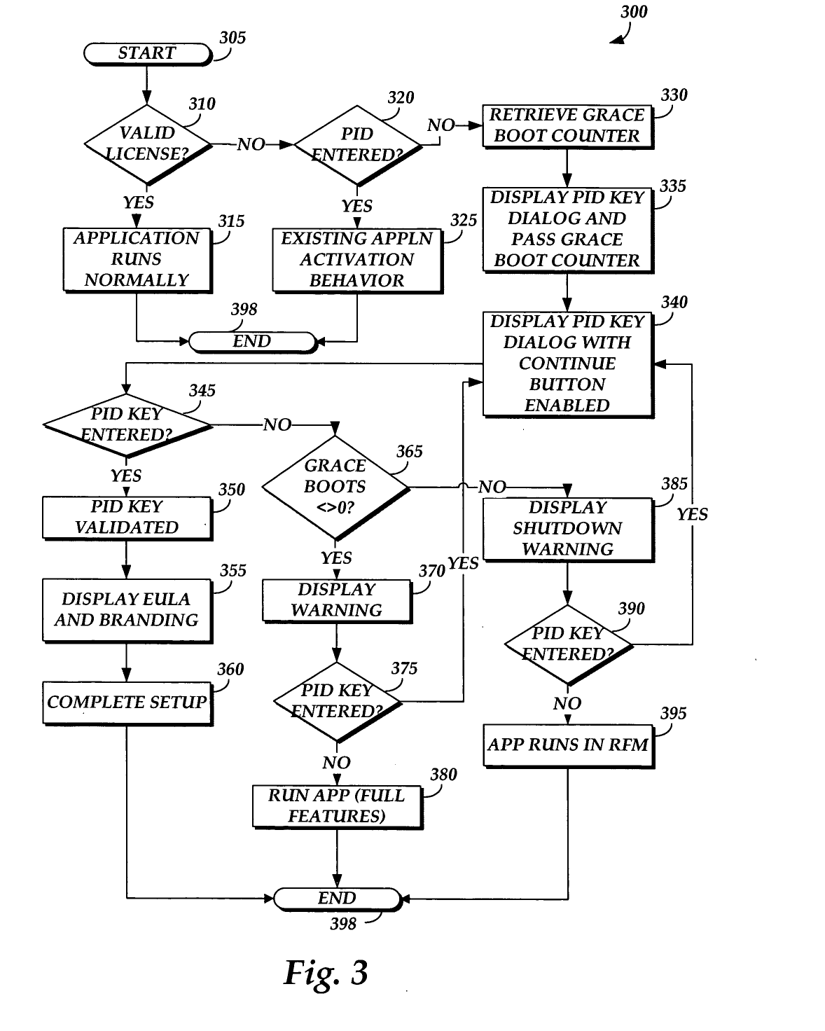

Referring now to FIG. 1B, an activation dialog box 100 is illustrated. As will be described below with reference to FIGS. 2 and 3, at various times during software application setup or during software application startup (boot), the licensing module 24 will cause the dialog box 100 to be displayed to provide an opportunity for entry of an appropriate product identification key code or other authorization code for properly activating a given software application. A text box 110 is provided in which the characters or digits of a product identification key code or other authorization code may be typed by a user. Alternatively, key codes may be copied and pasted into the text box 110 from a text document or other storage medium. A button 120 is provided for selectively sending the entered product identification key code or authorization code to the licensing module 24 for initiation of the activation process. A button or control 125 is provided for allowing a user to selectively continue with application setup or startup without entering a product identification key code and for using the application during a prescribed grace period, as described herein. According to embodiments, when a product identification key code or other authorization code is being entered in the text box 110, the button 125 is disabled from use. For example, the button 125 may be “grayed out” to indicate that the button may not be utilized. On the other hand, when no text is entered into the text box, indicating that no product identification key code or authorization code is being entered, the button 125 is enabled to allow the user to selectively continue with application setup or startup without entry of a product identification key code or other authorization code. A grace boots remaining counter box 130 may be provided in the dialog box 100 for indicating the number of startups or boots of the application that remain during the grace period. Alternatively the box 130 may display a remaining time period, for example, 2 days, during which un-activated use of the application may continue. As should be appreciated, the dialog box 100 is for purposes of illustration only and is not limiting of the various layouts and designs that may be utilized for the dialog box 100.

Referring now to FIG. 2, a logical flow diagram illustrating a method for software application setup is provided. Consider the logical flow illustrated in FIG. 2 in association with an example setup of a software application, for example, a word processing application 28, on a computer 2 purchased by a user for preparing a variety of word processing application documents. The method 200 begins at start operation 205 and proceeds to operation 210 after an example purchased software application 28 has been loaded onto the computer 2. At operation 210, the licensing module 24 causes a display of the activation dialog box 100 for entry of a product identification key code or other authorization code provided with the purchased software application.

At operation 215, the user may begin entry of the product identification key code as requested in the displayed dialog box 100. At operation 220, once the user begins entry of the characters of the product identification key code or other authorization code, the button 125, for allowing the user to continue with setup without entry of the product identification key code, is disabled. That is, once the user begins entry of product identification key code or other authorization code characters, the licensing module 24 assumes that the user intends to enter the required product identification key code, and the button 125, for allowing the user to setup the application without entry of the key code, is disabled.

At operation 225, the product identification key code or other authorization code digits are entered, and at decision operation 230, a determination is made by the licensing module 24 as to whether the product identification key code or other authorization code entered by the user is valid. If the key code entered by the user is not valid, a warning is provided at operation 235, and the method proceeds back to operation 225 to allow the user to correct the entered key code. If the product identification key code or other authorization code entered by the user is valid, the method proceeds to operation 250, and a continuation of the setup of the software application is enabled, as described below.

Referring back to operation 220, if the user decides to forego entry of the product identification key code and to make use of the prescribed grace period, the method may proceed to operation 240, and the user may clear the entered product identification key code. If the user clears the product identification key code characters entered at operation 225, the method proceeds to operation 245, and the button 125, for allowing the user to set up the software application without entry of the required product identification key code, is enabled. The method then proceeds to operation 265 where the user may select the button 125 for setting up the software application without entry of the product identification key code or other required authorization code.

Referring back to operation 210, when the activation dialog box 100 is initially launched after loading the software application onto the computer 2, the button 125 is enabled, as described above. If the user decides at this initial point to forego entry of the product identification key code and to make use of the prescribed grace period, the method proceeds directly to operation 265. At operation 265, the button 125 is selected for initiating a setup of the software application loaded by the user without requiring entry of the product identification key code or other required authorization code. At operation 270, a warning is displayed to the user to notify the user that the user is setting up the associated software application without entry of the required product identification key code and that the software application may be utilized by the user with a full feature set during a prescribed period after which the full feature set may be disabled. After receiving the product identification key code warning at operation 270, if the user decides to enter the product identification key code or other required authorization code, the method proceeds via operation 280 back to operation 210 where the activation dialog box 100 is provided to the user for entry of the product identification key code or other required authorization code.

After receiving the warning at operation 270, if the user desires to continue with application setup without entry of the required product identification key code or other required authorization code, the method proceeds via operation 275 to operation 285, and the licensing module 24 allows application setup to continue without receipt of the product identification key code. At operation 290, the licensing module 24 displays an end user licensing agreement (EULA) in which default product branding strings may be displayed in association with application setup without entry of the required product identification key code. For example, information may be provided in the EULA that notifies the user that an enhanced or reduced feature set may be provided for the software application during the grace period until the appropriate product identification key code or other authorization code is entered. After acceptance of the EULA by the user, the software application may be booted and utilized during the grace period, as described herein. The method ends at operation 295.

Referring now to FIG. 3, a logical flow diagram illustrating a method for application startup is described. Consider for example that a software application setup without entry of a required product identification key code or other required authorization code is performed as described above with reference to FIG. 2 and that a user subsequently decides to boot the application for use. The method 300 begins at start operation 305 and proceeds to decision operation 310 where a determination is made as to whether a valid license exists for the software application being booted by the user. If the application in question has been properly activated, then the method proceeds to operation 315, and the application runs normally in accordance with the licensed use of the application.

If a determination is made that a valid license for the software application is not present, the method proceeds to operation 320, and a determination is made as to whether a product identification key code or other authorization code has been entered by the user. According to an embodiment, at operation 320, the dialog box 100 may be displayed to the user at each attempted boot of the software application to remind the user that the user should enter the required product identification key code or other authorization code followed by software application activation. At operation 320, if the user enters a product identification key code, the method proceeds to operation 325, and the activation procedure prescribed for the software application in use may be performed. According to one embodiment, activation may not be performed at this time. While activation is the next step in the process, the user may elect to cancel and continue to use the software for any remaining grace period before activation is required. During this period, the feature set appropriate to the entered product identification key code is enabled. Thus, the grace period is independent of the feature set enabled or of the entered product key code.

Referring back to operation 320, if the user does not enter a product identification key code at operation 320, the method proceeds to operation 330, and the licensing module 24 retrieves a counter of the expended application grace boots. For example, if the grace period for the application in question includes 25 grace boots of the application, a counter is retrieved by the licensing module 24 to determine how many grace boots have been used for the software application since application setup, as described above with reference to FIG. 2. Alternatively, the licensing module 24 may determine the remaining grace period if the initial grace period is based on a prescribed amount of grace use time. At operation 335, the activation dialog box 100 may be displayed to provide the user with remaining grace period information and to allow the user to enter a product identification key code, if desired. At operation 340, the continue button 125 is enabled for allowing the user to continue use of the software application without entry of the product identification key code during the remaining term of the grace period.

At operation 345, if the user decides to enter the product identification key code, the method proceeds to operation 350, and product identification key code characters or digits entered by the user are validated. If a valid product identification key code is entered by the user, the EULA and associated branding information is provided at operation 355. At operation 360, setup of the software application including application activation may be completed as described above with reference to operation 325.

Referring back to operation 345, if a product identification key code or other authorization code is not entered by the user, the method proceeds to operation 365, and a determination is made as to whether prescribed grace boots for the grace period remain available for booting the software application. If prescribed grace boots do remain, or if prescribed grace time remains, the method proceeds to operation 370, and a warning may be displayed to the user to notify the user that the startup of the application is in accordance with the grace period, and a counter may be provided in the displayed warning by the licensing module 24 to notify the user of the remaining number of grace boots or grace time that may be used during the grace period.

At operation 375, according to an embodiment, the user may be once again provided the opportunity to enter the product identification key code or other authorization code as a part of the warning provided at operation 370. For example, if during the warning provided at operation 370, the user realizes that only one grace boot is left for the grace period, the user may decide that it is now time to enter the product identification key code or other required authorization code for activating the application for sustained use.

If the user decides not to enter the product identification key code, the method proceeds to operation 380, and the application is started up and runs with the full feature set provided by the licensing module 24 during the grace period. Referring back to operation 375, if the user decides to enter the product identification key code, the method proceeds back to operation 340, and the activation dialog box 100 is displayed, as described above.

Referring back to decision operation 365, if a determination is made by the licensing module 24 that no grace boots remain or that no grace time remains, the method proceeds to operation 385, and a shutdown warning is displayed to the user. That is, a warning is displayed to the user that the application will be shut down because the prescribed grace period has expired. Alternatively, instead of shutting down the application, the licensing module 24 may cause the application to run in a reduced functionality mode where many of the features of the application are disabled. According to embodiments, the warning displayed at operation 385 provides a button or control which when selected causes a display of the activation dialog box 100. If the user decides to enter the product identification key code at this time, the method proceeds back to operation 340, as described above. If the user decides not to enter the product identification key code after being warned that the grace period as expired, the method proceeds to operation 395, and the licensing module 24 causes the application to run in a reduced functionality mode where many of the functions and features of the application are disabled. Alternatively, the licensing module 24 may cause the application to shut down altogether. The method ends at operation 398.

As described herein, embodiments are directed to providing a grace period during which un-activated use of a software application is allowed. Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1. A method for providing un-activated use of a software application during a prescribed period, comprising:
receiving an indication of the loading of a software application;
requesting entry of activation information for the software application;
if activation information is not received, establishing a grace period during which the software application may be used without activation; and
allowing un-activated software application startup and use during the grace period.

2. The method of claim 1, wherein if activation information for the software application is received, initiating a software application activation process for registering the software application with an activation authority.

3. The method of claim 1, wherein establishing the grace period includes establishing a number of application startups that may be performed without activation.

4. The method of claim 1, wherein establishing the grace period includes establishing a prescribed time period during which the software application may be run without activation.

5. The method of claim 1, wherein requesting entry of activation information for the software application includes presenting a dialog box for receiving entry of a product identification key code.

6. The method of claim 5, whereby if a product identification key code is not entered, presenting a warning that un-activated use of the software application will expire at the end of the grace period.

7. The method of claim 6, wherein presenting the warning further includes providing a means for initiating activation of the software application.

8. The method of claim 7, wherein providing a means for initiating activation of the software application includes presenting a dialog box for receiving entry of a product identification key code.

9. The method of claim 6, wherein if a product identification key code is not entered, providing an end user license agreement notice that notifies a user of the software application during the grace period that the application may comprise different functionality than will be available from the application after the application is registered.

10. The method of claim 1, further comprising, at application startup, initiating a counter for tracking use of the software application during the grace period.

11. The method of claim 10, wherein initiating a counter for tracking use of the software application during the grace period includes initiating a counter of the number of application startups performed during the grace period.

12. The method of claim 10, wherein initiating a counter for tracking use of the software application during the grace period includes initiating a time counter to track a duration of use of the software application during the grace period.

13. The method of claim 1, further comprising, after an un-activated application startup, receiving a product identification key code entry.

14. The method of claim 13, wherein after receiving a product identification key code entry, requesting initiation of a software product activation process.

15. The method of claim 14, wherein if a software product activation process is not initiated, allowing continued un-activated application use during a remaining portion of the grace period.

16. The method of claim 15, wherein if the grace period has expired, presenting a warning that if a software activation process is not completed, the application will be placed in a reduced functionality mode.

17. A computer readable medium containing computer executable instructions which when executed by a computer perform a method for providing un-activated use of a software application during a prescribed period, comprising:
receiving an indication of the startup of a software application;
requesting entry of activation information for the software application;
if activation information is not received, establishing a grace period during which the software application may be used without activation;
allowing un-activated application use during the grace period;
initiating a counter for tracking use of the software application during the grace period; and
if the grace period expires without receipt of activation information, placing the software application in a reduced functionality mode until activation information is received.

18. The computer readable medium of claim 17, further comprising, after an un-activated application startup, further comprising:
receiving entry of a product identification key code entry;
requesting initiation of a software product activation process; and
if a software product activation process is not initiated, allowing continued un-activated application use during a remaining portion of the grace period.

19. A method for providing un-activated use of a software application during a prescribed period, comprising:
receiving an indication of the loading of a software application;
requesting entry of a product identification key code for the software application;
if a product identification key code is received initiating a software activation process for activating the software application with an activation authority;
if a product identification key code is not received, establishing a grace period during which the software application may be used without activation;
presenting a warning that un-activated use of the software application will expire at the end of the grace period; and
allowing un-activated software application startup and use during the grace period.

20. The method of claim 19, further comprising, at application startup, initiating a counter for tracking use of the software application during the grace period; and if the grace period expires, presenting a warning that if a product identification key code is not entered and a software activation process is not completed, the application will be placed in a reduced functionality mode.
